(19) United States
(12) Patent Application Publication
(10) Pub. No.: US 2012/0257053 A1
(43) Pub. Date: Oct. 11, 2012

(54) IMMORTAL BACKGROUND MODES

(75) Inventors: Amit Kumar Gupta, Liberty Grove (AU); Qianlu Lin, Artarmon (CN)

(73) Assignee: CANON KABUSHIKI KAISHA, Tokyo (JP)

(21) Appl. No.: 13/439,723

(22) Filed: Apr. 4, 2012

(30) Foreign Application Priority Data
Apr. 7, 2011 (AU) 2011201582

(51) Int. Cl. G06K 9/46; H04N 7/18; H04N 5/262

(52) U.S. Cl. 348/143; 382/190; 348/239

(57) ABSTRACT

A method and system for updating a visual element model of a scene model associated with a scene captured in an image sequence. The visual element model includes a set of mode models for a visual t corresponding to a location of the scene. The method identifies a first mode model from the set of mode models for the visual element model as a candidate deletion mode model. The method then removes the identified candidate deletion mode model from the set of mode models for the visual element model, to update the visual element model for the video sequence, when a first temporal attribute associated with the candidate deletion mode model satisfies a first threshold and a second temporal attribute associated with a second mode model in the set of mode models satisfies a second threshold (Tₖ).

### REFERENCE TO RELATED PATENT APPLICATION(S)

This application claims the benefit under 35 U.S.C. §119 of the filing date of Australian Patent Application No. 2011201582, filed Apr. 7, 2011, hereby incorporated by reference in its entirety as if fully set forth herein.

### TECHNICAL FIELD

The present disclosure relates to background-subtraction for foreground detection in images and, in particular, to the maintenance of a multi-appearance background model for an image sequence.

### BACKGROUND

A video is a sequence of images, which can also be called a video sequence or an image sequence. The images are also referred to as frames. The terms ‘frame’ and ‘image’ are used interchangeably throughout this specification to describe a single image in an image sequence. An image is made up of visual elements, for example, pixels, or 8×8 DCT (Discrete Cosine Transform) blocks, as used in JPEG images.

Scene modelling, also known as background modelling, involves the modelling of the visual content of a scene, based on an image sequence depicting the scene. Scene modelling allows a video analysis system to distinguish between transient foreground objects and the non-transient background, through a background-differencing operation.

One approach to scene modelling represents each location in the scene with a discrete number of mode models or appearances in a visual element model. That is, each location in the scene is associated with a visual element model in a scene model associated with the scene. Each visual element model includes a set of mode models. In the basic case, the set of mode models includes one mode model. In a multi-mode or multi-appearance implementation, the set of mode models includes a plurality of mode models. Each location in the scene corresponds to a visual element in each of the incoming video frames. In some existing techniques, a visual element is a pixel value. In other techniques, a visual element is a DCT (Discrete Cosine Transform) block. Each incoming visual element from the video frames is matched against the set of mode models in the visual element model at the corresponding location, and if the incoming visual element is similar to an existing mode model in the visual element model corresponding to the location of the incoming visual element, then the incoming visual element is considered to be a match to the existing mode model. If no match is found, then a new mode model is created to represent the incoming visual element. In some techniques, a visual element is considered to be background if the visual element is matched to an existing mode model, and foreground otherwise. In other techniques, the status of the visual element as either foreground or background depends on the properties of the mode model to which the visual element is matched. Such properties may include, for example, the creation time (“age”) of the visual element model.

Multi-visual-element-model techniques have significant advantages over single-model systems, because multi-visual-element-model techniques can represent and compensate for recurring appearances, such as a door being open and a door being closed, or a status light that cycles between being red and green and turned-off. As described above, multi-visual-element-model techniques store a set of mode models in each visual element model. An incoming visual element model is then compared to each mode model in the visual element model corresponding to the location of the incoming visual element.

A particular difficulty of multi-visual-element model approaches, however, is determining what mode models to keep in the system. As time passes, more and more mode models are created at the same visual element location. Keeping a large number of mode models in the system can result in processing time being slowed, and memory requirements increasing.

One approach is to limit to a fixed number, K, the number of stored mode models in a visual element model for a given visual element of a scene. For example, K is 5. The optimal value of K is different for different scenes and different applications.

Another known approach is to give each mode model a limited lifespan, or an expiry time. Known approaches set the expiry time depending on how many times a mode model has been matched, or when the mode model was created, or the time at which the mode model was last matched. In all cases, however, if the background has been occluded for a long time, the mode models representing the background are deleted. When the occlusion is removed and the background is revealed, the revealed background will be falsely detected as foreground, as the revealed background will not match an existing mode model.

Thus, a need exists to provide an improved method and system for maintaining a scene model for use in foreground-background separation of an image sequence.

### SUMMARY

It is an object of the present invention to overcome substantially, or at least ameliorate, one or more disadvantages of existing arrangements.

According to a first aspect of the present disclosure, there is provided a method of updating a visual element model of a scene model associated with a scene captured in an image sequence, the visual element model including a set of mode models for a visual element corresponding to a location of the scene, the method including:

identifying a first mode model from the set of mode models for the visual element model as a candidate deletion mode model; and

removing the identified candidate deletion mode model from the set of mode models for the visual element model, to update the visual element model for the video sequence, when a first temporal attribute associated with the candidate deletion mode model satisfies a first threshold and a second temporal attribute associated with a second mode model in the set of mode models satisfies a second threshold.

According to another aspect, disclosed is a method of updating a visual element model of a scene model associated with a scene captured in an image sequence. The visual element model includes a set of mode models for a visual element corresponding to a location of the scene. The method includes the steps of: identifying a first mode model from the set of mode models for the visual element model as a candidate deletion mode model; and removing the identified candidate deletion mode model from the set of mode models for the visual element model, to update the visual element model for the video sequence, if one of:
(a) a first temporal attribute associated with the candidate deletion mode model does not satisfy a first threshold; or
(b) the first temporal attribute associated with the candidate deletion mode model satisfies the first threshold and a second temporal attribute associated with a second mode model in the set of mode models satisfies a second threshold.

According to another, there is provided a method of updating a visual element representation of a scene representation associated with a scene captured in an image sequence, where visual element representation includes a set of modes for a visual element. This method includes identifying a mode from the set of modes for the visual element representation as a candidate deletion mode; and removing the identified candidate deletion mode from the set of modes for the visual element representation, to update the visual element representation for the video sequence, when the candidate deletion mode is a background mode and at least one other mode in the set of modes is also a background mode.

Also disclosed is a method of updating a visual element model of a scene model associated with a scene captured in an image sequence. The visual element model includes a set of mode models for a visual element corresponding to a location of the scene. The method includes the steps of: identifying a first mode model from the set of mode models for the visual element model as a candidate deletion mode model; and removing the identified candidate deletion mode model from the set of mode models for the visual element model, to update the visual element model for the video sequence, if one of:
(a) the candidate deletion mode model is a foreground mode model; or
(b) the candidate deletion mode model is a background mode model and at least one other mode model in the set of mode models is also a background mode model.

According to another aspect, there is provided a computer readable storage medium having recorded thereon a computer program for directing a processor to execute any of the methods discussed above.

According to a further aspect of the present disclosure, there is provided a camera system for capturing an image sequence. The camera system includes: a lens system; a sensor; a storage device for storing a computer program; a control module coupled to each of the lens system and the sensor to capture the image sequence; and a processor for executing the program. The program includes: computer program code for capturing at least one frame in an image sequence; computer program code for updating a visual element representation of a scene representation associated with a scene captured in the image sequence according to the method discussed above, and

computer program code for utilizing the scene representation to separate the foreground from the background in the scene of at least one image in the image sequence.

According to another aspect of the present disclosure, there is provided a method of performing video surveillance of a scene by utilizing a scene model associated with the scene. The scene model includes a plurality of visual elements, wherein each visual element is associated with a visual element model that includes a set of mode models. The method includes the steps of:

capturing an image sequence of the scene;

updating a visual element model of the scene model by:
identifying a first mode model from the set of mode models for the visual element model as a candidate deletion mode model;
removing the identified candidate deletion mode model from the set of mode models for the visual element model, to update the visual element model for the video sequence, if one of:
   (a) a first temporal attribute associated with the candidate deletion mode model does not satisfy a first threshold; or
   (b) the first temporal attribute associated with the candidate deletion mode model satisfies the first threshold and a second temporal attribute associated with a second mode model in the set of mode models satisfies a second threshold; and

utilizing the updated visual element model in foreground/background separation of at least one image in the image sequence.

According to a sixth aspect of the present disclosure, there is provided a method of updating a visual element model for a video sequence, the visual element model including a plurality of mode models for a visual element representing at least a portion of the video sequence. The method includes the steps of: identifying a mode model from the plurality of mode models for the visual element as a candidate deletion mode model; comparing a temporal attribute of the candidate deletion mode model to a first threshold; and removing the candidate deletion mode model of the visual element model, to update the visual element model for the video sequence, if:
(a) the candidate deletion mode model has the temporal attribute that satisfies the first threshold; and
(b) there are at least a pre-determined number of mode models that have the temporal attribute that satisfy a threshold associated with each of the mode models.

According to another aspect of the present disclosure, there is provided an apparatus for implementing any one of the aforementioned methods.

According to another aspect of the present disclosure, there is provided a computer program product including a computer readable medium having recorded thereon a computer program for implementing any one of the methods described above.

Other aspects are also disclosed.

### BRIEF DESCRIPTION OF THE DRAWINGS

At least one embodiment of the present invention will now be described with reference to the following drawings, in which:

FIG. 1 is a functional block diagram of a camera, upon which foreground/background segmentation is performed;

FIG. 2 is a block diagram of a scene model consisting of visual element models and an input frame;

FIG. 3 is a schematic block diagram of the process of matching an input image element to a visual element model;

FIG. 4 shows an example of deleting a mode model in the update phase;

FIG. 5 shows an example of deleting mode models in the deletion phase;

FIG. 6 shows four frames from a long video in which the background has been covered by a foreground object for long time, which causes the background to be falsely detected when it is revealed;

FIG. 7 is a schematic flow diagram illustrating a method of the deletion of models in the deletion phase;

FIG. 8 is a schematic flow diagram illustrating a method of the deletion of models in the update phase; and

FIGS. 9A and 9B form a schematic block diagram of a general purpose computer system upon which arrangements described can be practised.

### DETAILED DESCRIPTION INCLUDING BEST MODE

Where reference is made in any one or more of the accompanying drawings to steps and/or features that have the same reference numerals, those steps and/or features have for the purposes of this description the same function(s) or operation(s), unless the contrary intention appears.

The present disclosure relates to a method and system for maintaining a scene model associated with a scene depicted in an image sequence. The method functions by selectively removing from a scene model those elements that may otherwise cause side-effects. The scene model may be utilized to perform foreground/background separation on one or more images of the image sequence. Such foreground/background separation may then be used in a video analysis system or the like to perform video surveillance on the scene.

The present disclosure provides a method of updating a visual element model of a scene model associated with a scene captured in an image sequence. The image sequence includes a plurality of frames captured by one or more video cameras, wherein at least a portion of the scene falls within the field of view of the one or more video cameras. The visual element model includes a set of mode models for a visual element in the scene model, wherein the visual element corresponds to a location or position of the scene.

The method identifies a first mode model from the set of mode models for the visual element model as a candidate deletion mode model. The selection of the candidate mode model may be based, for example, upon an expiry time associated with the first mode model. The method updates the visual element model for the video sequence by removing the identified candidate deletion mode model from the set of mode models, if either one of two conditions is met.

The first condition is met when a first temporal attribute associated with the candidate deletion mode model does not satisfy a first threshold. The second condition is met when the first temporal attribute associated with the candidate deletion mode model satisfies the first threshold and a second temporal attribute associated with a second mode model in the set of mode models satisfies a second threshold. It is apparent that only one of the two conditions can be met at any time.

One implementation is directed to updating a visual element model by removing a mode model that has an associated expiry time that has passed, provided that the mode model is not the only background model for that visual element model. Identifying the candidate mode model may be based on the first mode model having an expiry time that has passed. Each mode model may be classified as a background mode model or a foreground mode model, based on the first threshold. If a first temporal attribute associated with the candidate deletion mode model is less than the first threshold and thus does not satisfy the first threshold, then the candidate deletion mode model is considered to be a foreground mode model and thus available for deletion or removal from the set of mode models.

If the first temporal attribute associated with the candidate deletion mode model is greater than or equal to the first threshold and thus satisfies the first threshold, then the candidate deletion mode model is considered to be a background mode model. However, in such an implementation the candidate mode model is not to be removed if the candidate mode model is the only background model. Thus, the method checks whether a second temporal attribute associated with a second mode model in the set of mode models satisfies a second threshold. If there is a second mode model that has an associated second temporal attribute that satisfies a second threshold, which means that the second mode model is also a background mode model, then the method removes the candidate deletion mode model.

In one arrangement, the first threshold and the second threshold are identical. In another arrangement, the first threshold and the second threshold are different. In such an arrangement, the first threshold may be utilized to determine whether the candidate mode model is sufficiently old to be considered as a background model and thus retained if that mode model is the only background model. If a candidate mode model is considered to be a background model, the second threshold may be used to determine whether there are any other mode models in the set of mode models that are sufficiently old to allow the candidate mode model to be deleted, even if the other mode models are not as old as the candidate mode model.

In one arrangement, the first temporal attribute associated with the candidate deletion mode model is a creation time. In one arrangement, the second temporal attribute associated with the second mode model is also a creation time. In another particular implementation, each mode model is associated with a creation time and an expiry time.

One implementation includes the further step of retaining the candidate deletion mode model in the set of mode models, if the first temporal attribute associated with the candidate deletion mode model satisfies the first threshold (the candidate deletion mode model is sufficiently old to be considered a background model) and there is no other mode model that has a second temporal attribute that satisfies the second threshold.

This implementation removes a mode model from the set of mode models and creates a new mode model based on data associated with the visual element of an input frame from the image sequence, if the first temporal attribute associated with the candidate deletion mode model does not satisfy the first threshold (the candidate deletion mode model is not sufficiently old to be considered to be considered a background model).

In another arrangement, a method for updating a scene model retains a mode model that has been selected as a candidate mode model for deletion, if that mode model is the only background mode model in a visual element model. Such a background mode model is retained, even if the mode model has an expiry time that has passed. Retaining such a background model facilitates the identification of background after a relatively long period of occlusion. Selecting the mode model as a candidate mode model for deletion may be dependent upon an expiry time associated with the mode model.

The method removes a mode model that has been selected as a candidate mode model for deletion from a set of mode models associated with a visual element model, if the mode model has a temporal attribute that satisfies a first threshold and there is at least one other mode model in the set of mode models associated with that visual element model that has a second temporal attribute that satisfies a second threshold.

In one implementation, the first threshold and the second threshold are the same. A mode model having a temporal attribute that satisfies the first threshold is classified as a background mode model, and such a background mode model is only removed if there is at least one other mode model that is also classified as a background model. This ensures that the only background model is not deleted.

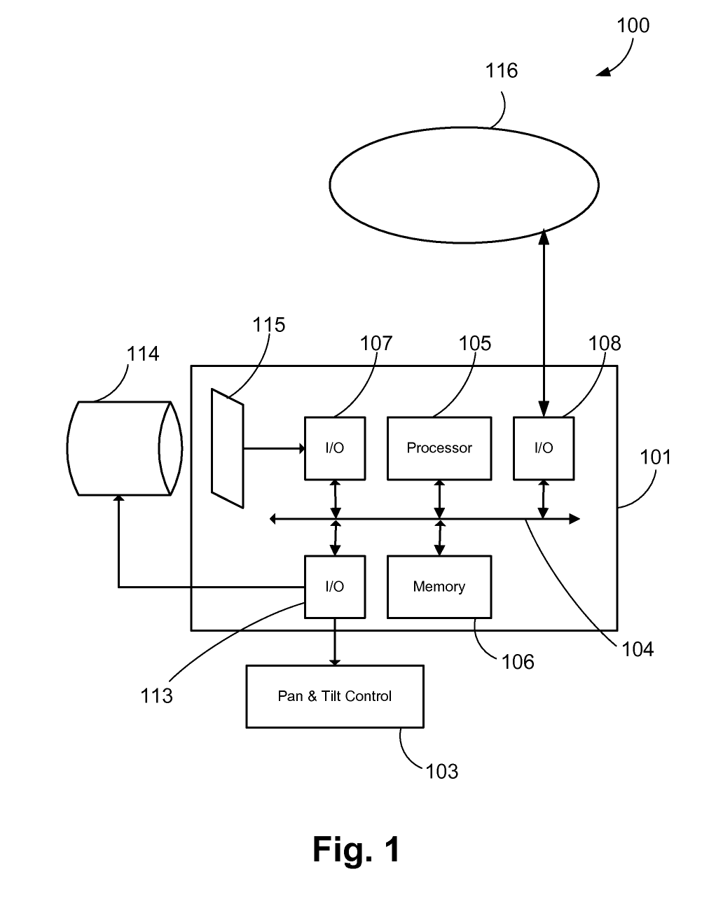

FIG. 1 shows a functional block diagram of a camera 100, upon which foreground/background segmentation may be performed. The camera 100 is a pan-tilt-zoom camera (PTZ) comprising a camera module 101, a pan and tilt control module 103, and a lens system 114. The camera module 101 typically includes at least one processor unit 105, a memory unit 106, a photo-sensitive sensor array 115, an input/output (I/O) interface 107 that couples to the sensor array 115, an input/output (I/O) interface 108 that couples to a communications network 116, and an input/output (I/O) interface 113 for the pan and tilt module 103 and the lens system 114. The components 107, 105, 108, 113 and 106 of the camera module 101 typically communicate via an interconnected bus 104 and in a manner that results in a conventional mode of operation known to those in the relevant art.

The camera 100 is used to capture video frames, also known as input images, representing the visual content of a scene appearing in the field of view of the camera 100. Each frame captured by the camera 100 comprises more than one visual element. A visual element is defined as an image sample. In one embodiment, the visual element is a pixel, such as a Red-Green-Blue (RGB) pixel. In another embodiment, each visual element comprises a group of pixels. In yet another embodiment, the visual element is an 8 by 8 block of transform coefficients, such as Discrete Cosine Transform (DCT) coefficients as acquired by decoding a motion-JPEG frame, or Discrete Wavelet Transformation (DWT) coefficients as used in the JPEG-2000 standard. The colour model is YUV, where the Y component represents the luminance, and the U and V represent the chrominance.

In one arrangement, the memory 106 stores a computer program with instructions for performing the method described herein for updating a visual element model of a scene model associated with a scene, wherein at least a portion of the scene falls within a field of view of the camera 100. The computer program is executed by the processor unit 105. In an alternative arrangement, the camera 100 transmits, via the communications network 116, an image sequence and related information to a computer system adapted to update a visual element model of a scene model.

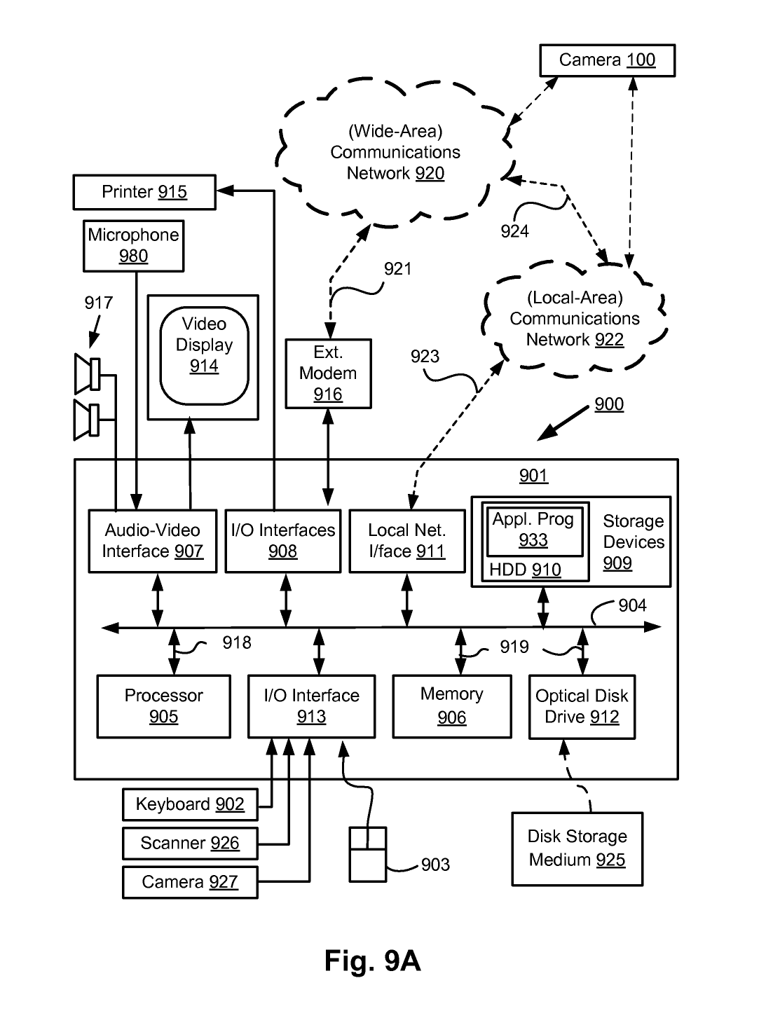

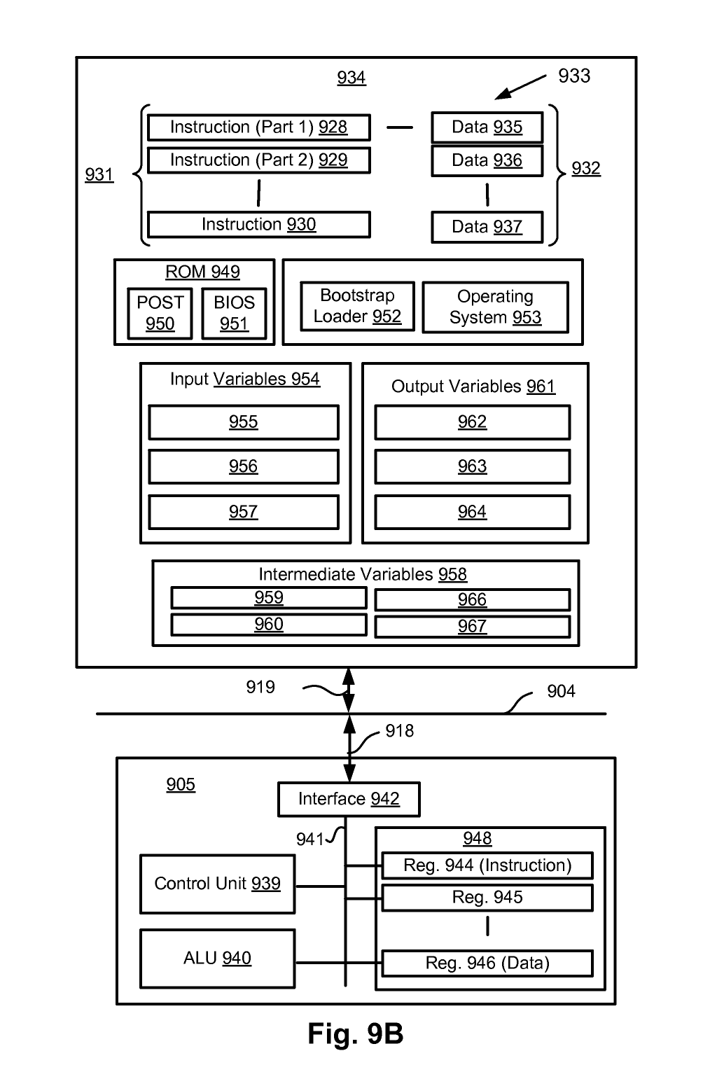

FIGS. 9A and 9B depict a general-purpose computer system 900, upon which the various arrangements described can be practised. In particular, a method and system for maintaining a scene model by updating a visual element model can be practised on the computer system 900. In one arrangement, a video analysis system for processing an image sequence of one or more images captured by one or more cameras 100 can be practised on the computer system 900. Such a video analysis system may include, for example, functionality for maintaining a scene model associated with a scene captured in the image sequence and utilizing the scene model to perform foreground/background separation on a plurality of images of the image sequence. The computer system 900 can be utilized in conjunction with one or more cameras 100, wherein the computer system 900 receives images and information from the camera(s) 100 to update the scene model.

As seen in FIG. 9A, the computer system 900 includes: a computer module 901; input devices such as a keyboard 902, a mouse pointer device 903, a scanner 926, a camera 927, and a microphone 980; and output devices including a printer 915, a display device 914 and loudspeakers 917. An external Modulator-Demodulator (Modem) transceiver device 916 may be used by the computer module 901 for communicating to and from a communications network 920 via a connection 921. The communications network 920 may be a wide-area network (WAN), such as the Internet, a cellular telecommunications network, or a private WAN. Where the connection 921 is a telephone line, the modem 916 may be a traditional “dial-up” modem. Alternatively, where the connection 921 is a high capacity (e.g., cable) connection, the modem 916 may be a broadband modem. A wireless modem may also be used for wireless connection to the communications network 920.

The computer module 901 typically includes at least one processor unit 905, and a memory unit 906. For example, the memory unit 906 may have semiconductor random access memory (RAM) and semiconductor read only memory (ROM). The computer module 901 also includes an number of input/output (I/O) interfaces including: an audio-video interface 907 that couples to the video display 914, loudspeakers 917 and microphone 980; an I/O interface 913 that couples to the keyboard 902, mouse 903, scanner 926, camera 927 and optionally a joystick or other human interface device (not illustrated); and an interface 908 for the external modem 916 and printer 915. The camera 927 may correspond to the camera 100 of FIG. 1. In some implementations, the modem 916 may be incorporated within the computer module 901, for example within the interface 908. The computer module 901 also has a local network interface 911, which permits coupling of the computer system 900 via a connection 923 to a local-area communications network 922, known as a Local Area Network (LAN). As illustrated in FIG. 9A, the local communications network 922 may also couple to the wide network 920 via a connection 924, which would typically include a so-called “firewall” device or device of similar functionality. The local network interface 911 may comprise an Ethernet™ circuit card, a Bluetooth™ wireless arrangement or an IEEE 802.11 wireless arrangement; however, numerous other types of interfaces may be practiced for the interface 911. In one arrangement, the computer 900 couples to a camera 100 via either one or both of the local-area communications network 922 or the wide area communications network 920.

The I/O interfaces 908 and 913 may afford either or both of serial and parallel connectivity, the former typically being implemented according to the Universal Serial Bus (USB) standards and having corresponding USB connectors (not illustrated). Storage devices 909 are provided and typically include a hard disk drive (HDD) 910. Other storage devices such as a floppy disk drive and a magnetic tape drive (not illustrated) may also be used. An optical disk drive 912 is typically provided to act as a non-volatile source of data. Portable memory devices, such optical disks (e.g., CD-ROM, DVD, Blu-ray Disc™), USB-RAM, portable, external hard drives, and floppy disks, for example, may be used as appropriate sources of data to the system 900.

The components 905 to 913 of the computer module 901 typically communicate via an interconnected bus 904 and in a manner that results in a conventional mode of operation of the computer system 900 known to those in the relevant art. For example, the processor 905 is coupled to the system bus 904 using a connection 918. Likewise, the memory 906 and optical disk drive 912 are coupled to the system bus 904 by connections 919. Examples of computers on which the described arrangements can be practised include IBM-PCs and compatibles, Sun Sparcstations, Apple Mac™ or alike computer systems.

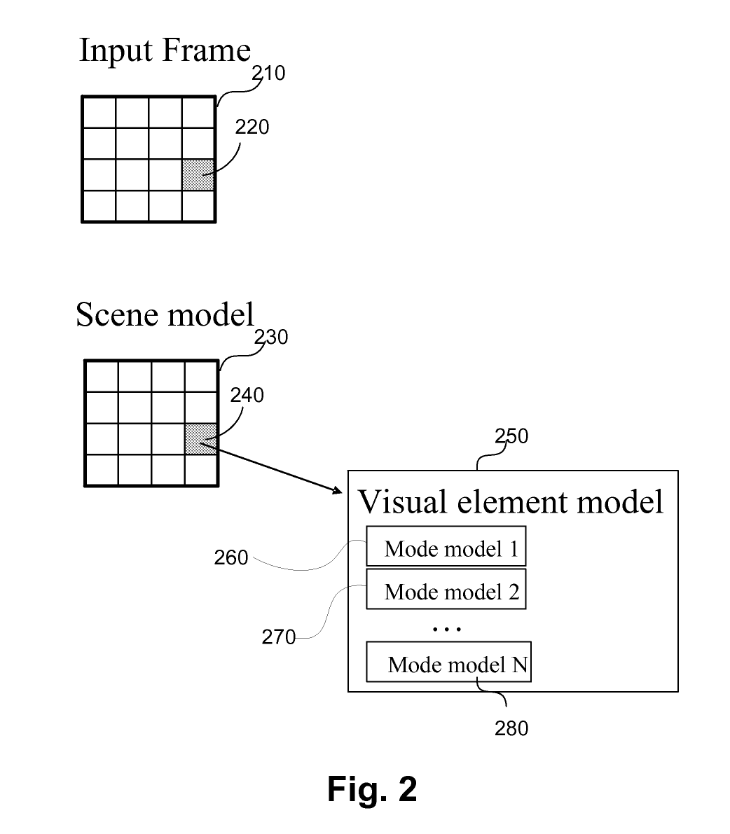

The method of updating a visual element model for a scene model may be implemented using the computer system 900 wherein the processes of FIGS. 2 to 8, to be described, may be implemented as one or more software application programs 933 executable within the computer system 900. In particular, the steps of the method of updating a visual element model for a scene model are effected by instructions 931 (see FIG. 9B) in the software 933 that are carried out within the computer system 900. The software instructions 931 may be formed as one or more code modules, each for performing one or more particular tasks. The software may also be divided into two separate parts, in which a first part and the corresponding code modules performs the updating visual element model methods and a second part and the corresponding code modules manage a user interface between the first part and the user.

The software 933 is typically stored in the HDD 910 or the memory 906. The software is loaded into the computer system 900 from a computer readable medium, and executed by the computer system 900. Thus, for example, the software 933 may be stored on an optically readable disk storage medium (e.g., CD-ROM) 925 that is read by the optical disk drive 912. A computer readable medium having such software or computer program recorded on it is a computer program product. The use of the computer program product in the computer system 900 preferably effects an apparatus for updating a visual element model in a scene model. The scene model may be utilized to perform foreground/background separation on an image sequence, and may form part of a video analysis system for performing video surveillance.

In some instances, the application programs 933 may be supplied to the user encoded on one or more CD-ROMs 925 and read via the corresponding drive 912, or alternatively may be read by the user from the networks 920 or 922. Still further, the software can also be loaded into the computer system 900 from other computer readable media. Computer readable storage media refers to any non-transitory tangible storage medium that provides recorded instructions and/or data to the computer system 900 for execution and/or processing. Examples of such storage media include floppy disks, magnetic tape, CD-ROM, DVD, Blu-ray Disc, a hard disk drive, a ROM or integrated circuit, USB memory, a magneto-optical disk, or a computer readable card such as a PCMCIA card and the like, whether or not such devices are internal or external of the computer module 901. Examples of transitory or non-tangible computer readable transmission media that may also participate in the provision of software, application programs, instructions and/or data to the computer module 901 include radio or infra-red transmission channels as well as a network connection to another computer or networked device, and the Internet or Intranets including e-mail transmissions and information recorded on Websites and the like.

The second part of the application programs 933 and the corresponding code modules mentioned above may be executed to implement one or more graphical user interfaces (GUIs) to be rendered or otherwise represented upon the display 914. Through manipulation of typically the keyboard 902 and the mouse 903, a user of the computer system 900 and the application may manipulate the interface in a functionally adaptable manner to provide controlling commands and/or input to the applications associated with the GUI(s). Other forms of functionally adaptable user interfaces may also be implemented, such as an audio interface utilizing speech prompts output via the loudspeakers 917 and user voice commands input via the microphone 980.

FIG. 9B is a detailed schematic block diagram of the processor 905 and a “memory” 934. The memory 934 represents a logical aggregation of all the memory modules (including the HDD 909 and semiconductor memory 906) that can be accessed by the computer module 901 in FIG. 9A.

When the computer module 901 is initially powered up, a power-on self-test (POST) program 950 executes. The POST program 950 is typically stored in a ROM 949 of the semiconductor memory 906 of FIG. 9A. A hardware device such as the ROM 949 storing software is sometimes referred to as firmware. The POST program 950 examines hardware within the computer module 901 to ensure proper functioning and typically checks the processor 905, the memory 934 (909, 906), and a basic input-output systems software (BIOS) module 951, also typically stored in the ROM 949, for correct operation. Once the POST program 950 has run successfully, the BIOS 951 activates the hard disk drive 910 of FIG. 9A. Activation of the hard disk drive 910 causes a bootstrap loader program 952 that is resident on the hard disk drive 910 to execute via the processor 905. This loads an operating system 953 into the RAM memory 906, upon which the operating system 953 commences operation. The operating system 953 is a system level application, executable by the processor 905, to fulfil various high level functions, including processor management, memory management, device management, storage management, software application interface, and generic user interface.

The operating system 953 manages the memory 934 (909, 906) to ensure that each process or application running on the computer module 901 has sufficient memory in which to execute without colliding with memory allocated to another process. Furthermore, the different types of memory available in the system 900 of FIG. 9A must be used properly so that each process can run effectively. Accordingly, the aggregated memory 934 is not intended to illustrate how particular segments of memory are allocated (unless otherwise stated), but rather to provide a general view of the memory accessible by the computer system 900 and how such is used.

As shown in FIG. 9B, the processor 905 includes a number of functional modules including a control unit 939, an arithmetic logic unit (ALU) 940, and a local or internal memory 948, sometimes called a cache memory. The cache memory 948 typically include a number of storage registers 944-946 in a register section. One or more internal busses 941 functionally interconnect these functional modules. The processor 905 typically also has one or more interfaces 942 for communicating with external devices via the system bus 904, using a connection 918. The memory 934 is coupled to the bus 904 using a connection 919.

The application program 933 includes a sequence of instructions 931 that may include conditional branch and loop instructions. The program 933 may also include data 932 which is used in execution of the program 933. The instructions 931 and the data 932 are stored in memory locations 928, 929, 930 and 935, 936, 937, respectively. Depending upon the relative size of the instructions 931 and the memory locations 928-930, a particular instruction may be stored in a single memory location as depicted by the instruction shown in the memory location 930. Alternatively, an instruction may be segmented into a number of parts each of which is stored in a separate memory location, as depicted by the instruction segments shown in the memory locations 928 and 929.

In general, the processor 905 is given a set of instructions which are executed therein. The processor 1105 waits for a subsequent input, to which the processor 905 reacts to by executing another set of instructions. Each input may be provided from one or more of a number of sources, including data generated by one or more of the input devices 902, 903, data received from an external source across one of the networks 920, 902, data retrieved from one of the storage devices 906, 909 or data retrieved from a storage medium 925 inserted into the corresponding reader 912, all depicted in FIG. 9A. The execution of a set of the instructions may in some cases result in output of data. Execution may also involve storing data or variables to the memory 934.

The disclosed arrangements for updating a visual element model use input variables 954, which are stored in the memory 934 in corresponding memory locations 955, 956, 957. The arrangements for updating a visual element model produce output variables 961, which are stored in the memory 934 in corresponding memory locations 962, 963, 964. Intermediate variables 958 may be stored in memory locations 959, 960, 966 and 967.

Referring to the processor 905 of FIG. 9B, the registers 944, 945, 946, the arithmetic logic unit (ALU) 940, and the control unit 939 work together to perform sequences of micro-operations needed to perform “fetch, decode, and execute” cycles for every instruction in the instruction set making up the program 933. Each fetch, decode, and execute cycle comprises:

(a) a fetch operation, which fetches or reads an instruction 931 from a memory location 928, 929, 930;

(b) a decode operation in which the control unit 939 determines which instruction has been fetched; and

(c) an execute operation in which the control unit 939 and/or the ALU 940 execute the instruction.

Thereafter, a further fetch, decode, and execute cycle for the next instruction may be executed. Similarly, a store cycle may be performed by which the control unit 939 stores or writes a value to a memory location 932.

Each step or sub-process in the processes of FIGS. 2 to 8 is associated with one or more segments of the program 933 and is performed by the register section 944, 945, 947, the ALU 940, and the control unit 939 in the processor 905 working together to perform the fetch, decode, and execute cycles for every instruction in the instruction set for the noted segments of the program 933.

The method of updating a visual element model in a scene model may alternatively be implemented in dedicated hardware such as one or more integrated circuits performing the functions or sub functions of identifying a candidate mode model, and removing the identified candidate mode model. Such dedicated hardware may include graphic processors, digital signal processors, or one or more microprocessors and associated memories.

FIG. 2 depicts a schematic block diagram representation of an input frame 210 and a scene model 230 associated with a scene captured in the input frame 210. The input frame 210 includes a plurality of visual elements and the scene model 230 includes a corresponding plurality of visual element models. In the example of FIG. 2, the scene model 230 includes a visual element model 240. In one arrangement, the scene model 230 is stored in the memory 106 of the camera 100. In another arrangement, the scene model 230 is stored in a memory of a remote server, such as the memory 906 of the computer system 900, or database coupled to the camera 100 by a communications link. The communications link may include a wired or wireless transmission path and may be a dedicated link, a wide area network (WAN), a local area network (LAN), or other communications network, such as the Internet.

As indicated above, the input frame 210 includes a plurality of visual elements. In the example of FIG. 2, an exemplary visual element in the input frame 210 is visual element 220. The visual element 220 is positioned at a location in the scene 210 corresponding to the visual element model 240 of the scene model 230 associated with the scene captured in the input frame 210. A visual element is the elementary unit at which processing takes place, and the visual element is captured by an image sensor, such as the photo-sensitive sensor array 115 of the camera 100. In one arrangement, the visual element is a pixel. In another arrangement, the visual element is an 8×8 DCT block. In one arrangement, the processing takes place on the processor 105 of the camera 100.

The scene model 230 includes a visual element model 240. For each input visual element of the input frame 210 that is modelled, a corresponding visual element model is maintained in the scene model 230. In the example of FIG. 2, the input visual element 220 has a corresponding visual element model 240 in the scene model 230. The visual element model 240 includes a set of mode models. The set of mode models may initially be empty and is then populated with a mode model either before processing a first frame, based on an expected scene or other data, or as a result of processing a first frame, based on information in the first frame. The set of mode models will then have one or more models for the processing of further frames. In the example of FIG. 2, the visual element model 240 includes a set of mode models that includes mode model 1 260, mode model 2 270, . . . , mode model N 280. Each mode model is based on a history of values for the visual element. There can be several mode models corresponding to the same location in the captured input frame 210. For example, if there is a flashing neon light in the scene captured by an image sequence, one mode model represents “background—light on”, another mode model represents “background—light off”, and yet another mode model represents “foreground”, such as part of a passing car. In one arrangement, the mode model is the mean value of pixel intensity values. In another arrangement, the mode model is the median or the approximated median of observed DCT coefficient values for each DCT coefficient, and the mode model records temporal characteristics.

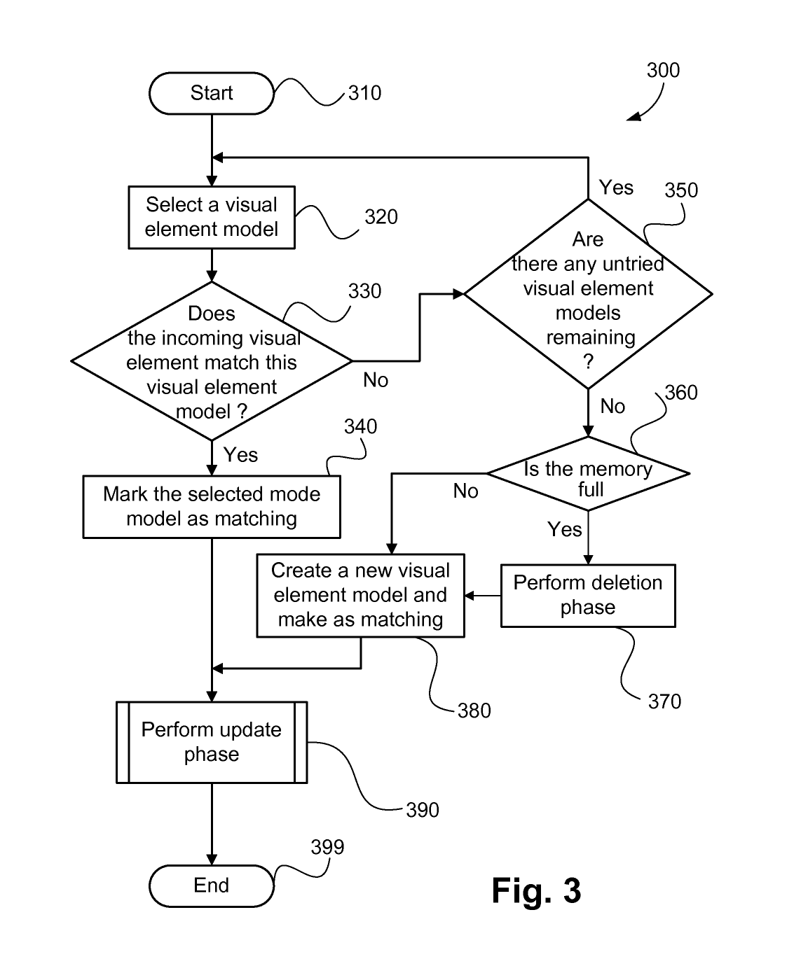

FIG. 3 is a flow diagram illustrating a process 300 for matching an incoming visual element of an input frame to a mode model from a visual element model in an associated scene model. The process 300 begins at a Start step 310 when an incoming visual element 220 from an input frame 210 captured by a camera is to be matched to a mode model in a visual element model 240 at the corresponding location in the scene model 230. Control passes from step 310 to step 320, which selects a single mode model from a set of mode models in the visual element model 250. Control then passes to a first decision step 330, which compares the selected mode model against the incoming visual element 220 to test for a match.

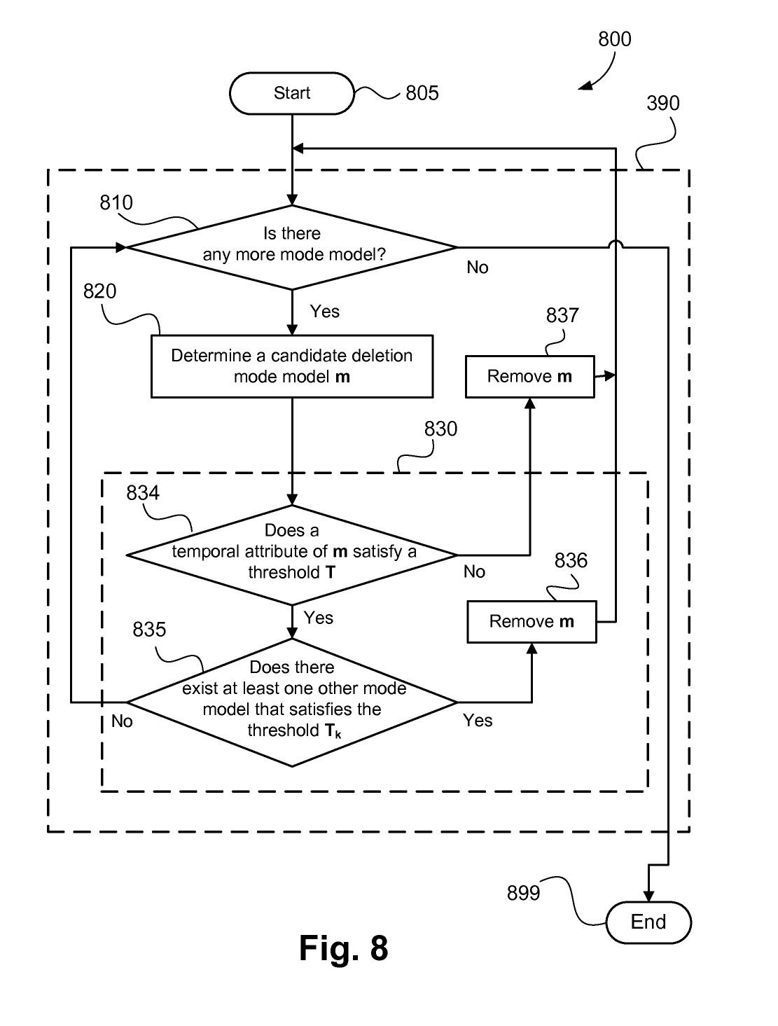

If step 330 determines that the incoming visual element 220 and the selected visual element model match, Yes, then control passes from step 330 to step 340, which marks the currently selected mode model as being matching. Control then passes from step 340 to an update phase 390, which is described in greater detail below with reference to FIG. 8, before the matching process terminates at an End step 399.

Returning to step 330, if the incoming visual element does not match the currently selected mode model, No, then control passes to a second decision step 350, which checks to see if all of the available mode models at the visual element model corresponding to the location of the incoming visual element have been tried. If there are mode models remaining in the visual element model that are untried, Yes, then control returns to step 320 to try to match the incoming visual element with one of the untried mode models.

If at step 350 there are no untried mode models remaining, No, then control passes to a third decision step 360 to determine whether the memory space to store the visual element model is full 360. That is, is there sufficient memory space to create a new mode model in the set of mode models in the visual element model. In one embodiment, the memory space of a visual element model is the maximum number of mode models the visual element can contain. When the number of mode models stored in the visual element model is equal to the maximum number, the visual element model is full. If step 360 determines that the space of the visual element model is not full, No, then control passes to step 380 to create a new mode model to represent the incoming visual element 220. Step 380 also marks the new mode model as matching, before control is passed to the update phase 390, and the method 300 then terminates at the End step 399.

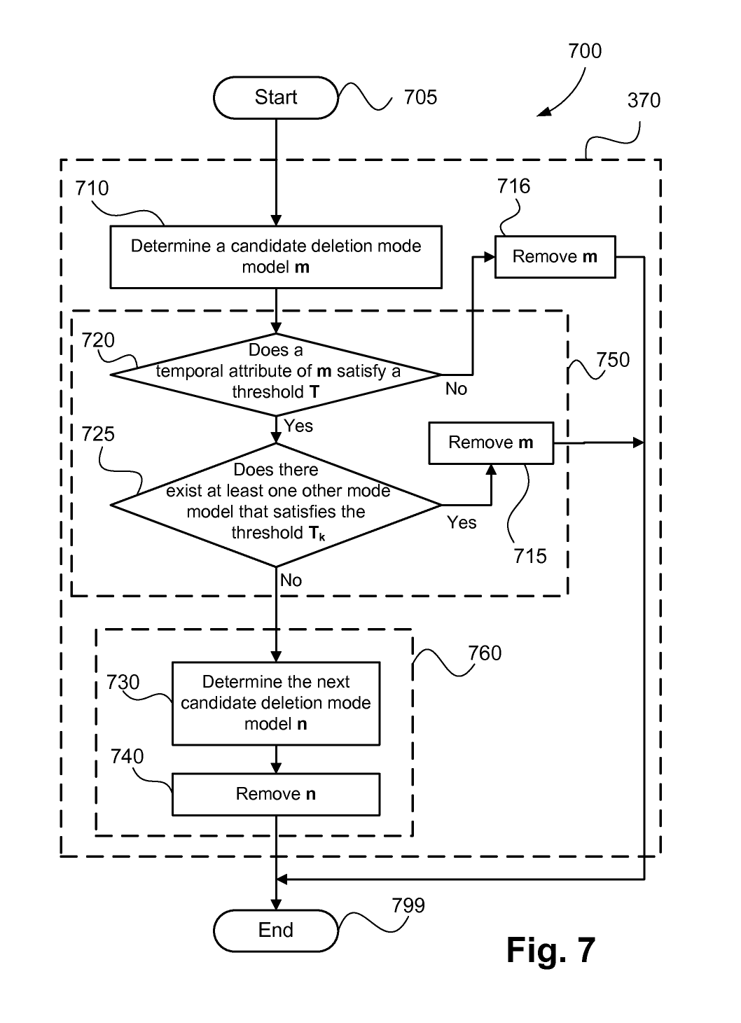

Returning to step 360, if the memory space of the visual element model is full, Yes, then control passes to a deletion phase 370, which is described in greater detail below with reference to FIG. 7. After a mode model is deleted from the visual element model 250 in step 370, control passes to step 380 to create a new mode model and mark the new mode model as matching. Control then passes to perform update phase 390, before the matching process 300 terminates at the End step 399.

As shown in FIG. 3, deleting mode models only happens in the deletion phase 370 and the update phase 390.

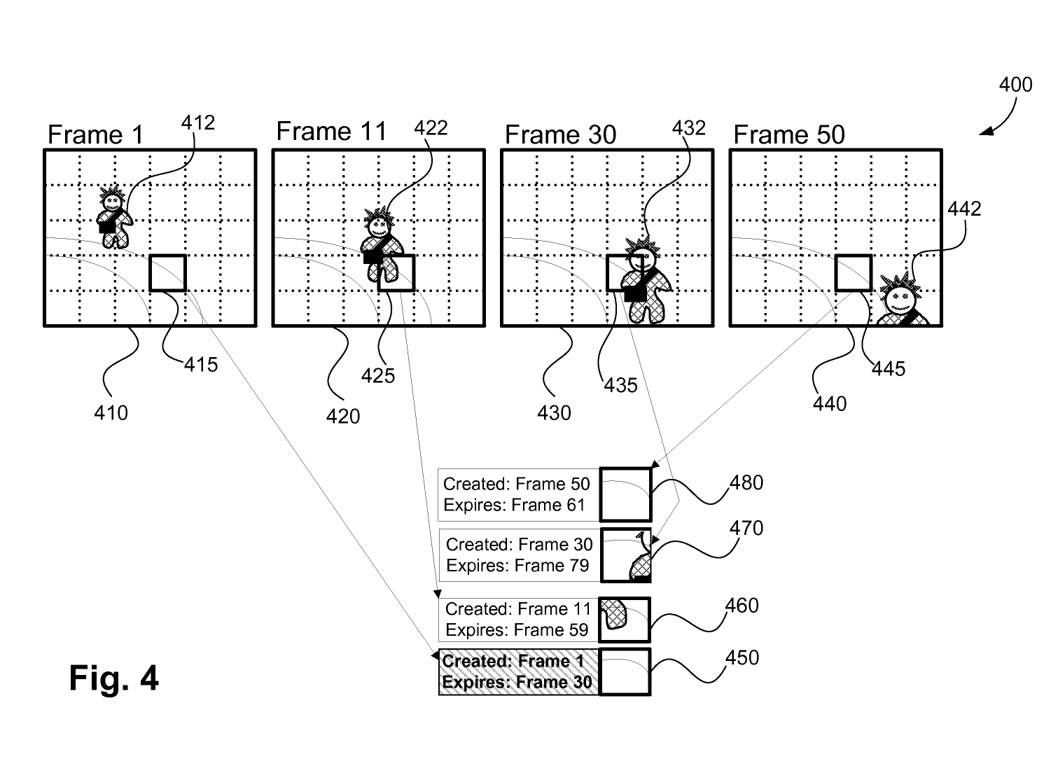

FIG. 4 shows an example of a mode model being deleted in an update phase 400 corresponding to step 390 of FIG. 3. The example of FIG. 4 shows a series of successive, but not necessarily consecutive, input frames from a video sequence: frame 1 410, frame 11 420, frame 30 430, and frame 50 440. Each of the input frames has a plurality of visual elements. In this example, a visual element 415 in frame 1 410 is at a corresponding location to: a visual element 425 in frame 11 420, a visual element 435 in the frame 30 430, and a visual element 445 in frame 50 440. Similarly, a person 412 in frame 1 410 corresponds to: a person 422 in frame 11 420, a person 432 in frame 30 430, and a person 442 in frame 50 440. Frames 1, 11, 30, and 50 are frames in the video sequence in which visual elements 415, 425, 435, and 445, at the same location in the frame, change relative to the respective preceding frame. Thus, from frames 1 to 10 the visual element at the location of visual element 415 keeps matching mode model 450 until frame 11, at which point visual element 425 changes to something different from 415.

Frame 1 410 includes the incoming visual element 415 that matches to a background mode model 450. The mode model 450 is recorded as being created in frame 1. In frame 11 420, however, a person 422 partly affects the appearance of the visual element 425 at the location corresponding to visual element 415 of frame 1 410. The matching method 300 creates a new mode model 460, as described with reference to step 380 in FIG. 3, because the appearance of the visual element 425 is different from the mode model 450 that was previously matched for that location. The newly created mode model 460 is recorded as being created in frame 11 420. The mode model 450 created in frame 1 410 has been last matched in frame 10, and is given an expiry time. In one embodiment, the expiry time is calculated as:

Expiry_Time=Last_Matched_Frame_Num+a*Hit_Count+b Eqn (1)

where
Last_Matched_Frame_Num is the frame number in which the mode model was last matched;
Hit_Count is the number of the frames the mode model has been seen since it is created;
a and b are the parameters.

In this example, a is equal to 1 and b is equal to 10. The parameter ‘a’ controls the importance of hit-count in estimating the expiry time. A high value of ‘a’ means a mode model with high hit-count is expected to be hit again and thus should have a high expiry time. The parameter ‘b’ represents the number of frames in which we expect a mode model to reappear after matching, irrespective of its hit-count. The parameter ‘b’ is mainly effective for very young modes (with low hit_counts). In this example, a is equal to 1 and b is equal to 10. Using Eqn (1), the mode model 450 is given an expiry time at frame 30.

Frame 30 430 shows that the same person 432 has moved from the previous position in the frame and affects the visual element 435 at the same location 425 as previously described with reference to frame 11 420. Using the same matching process again, as described with reference to FIG. 3, a new mode model 470 is created, because the appearance of the incoming visual element 435 does not resemble the appearance stored in the existing mode models 450 and 460. The newly created mode model 470 is recorded as being created in frame 30 430. The mode model 460 created in frame 11 420 has been last matched in frame 29, therefore, the mode model 460 is given an expiry time at frame 59, obtained using Eqn (1). Also, the mode model 450 is deleted, because mode model 450 is marked to be expired in frame 30 in step 390 in FIG. 3.

In frame 50 440, the same person 442 moves again and reveals the occupied background. Thus, the visual element at the location under consideration 445 appears as that location did earlier in frame 1 415. However, the mode model 450 created in frame 1 410 was deleted in frame 30. Therefore, a new mode model 480 is created. The newly created mode model 480 is recorded as being created in frame 50 440 and is given an expiry time at frame 61, obtained using Eqn (1). The mode model 470 created in frame 30 430 is given an expiry time, frame 79, using Eqn (1).

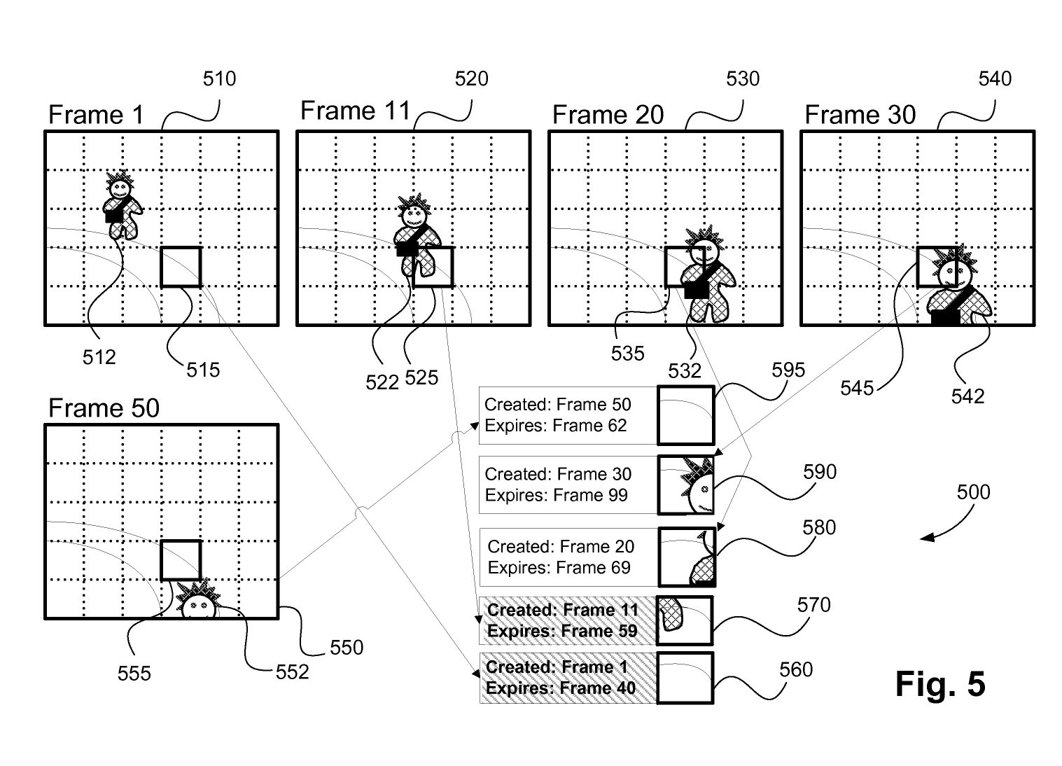

FIG. 5 shows an example of a mode model being deleted in a deletion phase 500 corresponding to step 370 of FIG. 3. In the example, the multi-visual-element mode matching system keeps up to three mode models in each visual element model 250. The example of FIG. 5 shows a series of successive, but not necessarily consecutive, input frames from a video sequence: frame 1 510, frame 11 520, frame 20 530, frame 30 540, and frame 50 550. Each of the input frames has a plurality of visual elements. In this example, a visual element 515 in frame 1 510 is at a corresponding location to: a visual element 525 in frame 11 520, a visual element 535 in the frame 20 530, a visual element 545 in frame 30 540, and a visual element 555 in frame 50 550. Similarly, a person 512 in frame 1 510 corresponds to: a person 522 in frame 11 520, a person 532 in frame 20 530, a person 542 in frame 30 540, and a person 552 in frame 50 550.

The incoming visual element 515 from frame 1 510 of the video sequence matches to a background mode model 560. The mode model 560 is recorded as being created in Frame 1 510.

In frame 11 520, however, the person 522 partly affects the appearance of the visual element 525 at the location corresponding to visual element 515 of frame 1 510. The matching method 300 creates a new mode model 570, as described with reference to step 380 in FIG. 3, because the appearance of the visual element 525 is different from the mode model 560 that was previously matched for that location. The newly created mode model 570 is recorded as being created in frame 11 520. The mode model 560 created in frame 1 510 has last been matched in frame 10, and is given an expiry time, frame 40, using Eqn (1). In this example, a in Eqn (1) is equal to 20, and b in Eqn (1) is equal to 10.

Frame 20 530 shows that the same person 532 has moved from the previous position in the frame and affects the visual element 535 at the same location 525 as previously described with reference to frame 11 520. Using the same matching process again, as described with reference to FIG. 3, a new mode model 580 is created, because the appearance of the incoming visual element 535 does not resemble the appearance stored in the existing mode models 560 and 570. The newly created mode model 580 is recorded as being created in frame 20 530. The mode model 570 created in frame 11 520 has last been matched in frame 19, and is given an expiry time, frame 59, obtained using Eqn (1).

In frame 30 540, the same person 542 moves again, which affects the visual element at the location 545 under consideration. Using the same matching process again, as described above with reference to FIG. 3, a new mode model 590 is created. However, the exemplary system keeps only three mode models. An existing mode model is to be deleted to make room for the new mode model 590. The mode model 560 created in Frame 1 has the earliest expiry time, frame 40. Accordingly, mode model 560 is deleted and then new mode model 590 is created. The newly created mode model 590 is recorded as being created in frame 30 540. The mode model 580 created in frame 20 530 has been last matched in frame 29. Therefore, mode model 580 is given an expiry time, frame 69, obtained using Eqn (1).

In frame 50 550, the same person 552 moves away from the previous position, and the background is revealed. However, the mode model 560 for the background was deleted in frame 30. Therefore, a new mode model 595 is to be created. Again, the exemplary system only allows three mode models to be kept in every visual element model 250. The mode model 570 created in frame 11 has the earliest expiry time. Therefore, mode model 570 is deleted and then mode model 595 is created. The newly created mode model 595 is recorded as being created in frame 50 550, and is given an expiry time 62, obtained using Eqn (1). Also, mode model 590 created in frame 30 540 has last been matched in frame 49, and is given a new expiry time at frame 99.

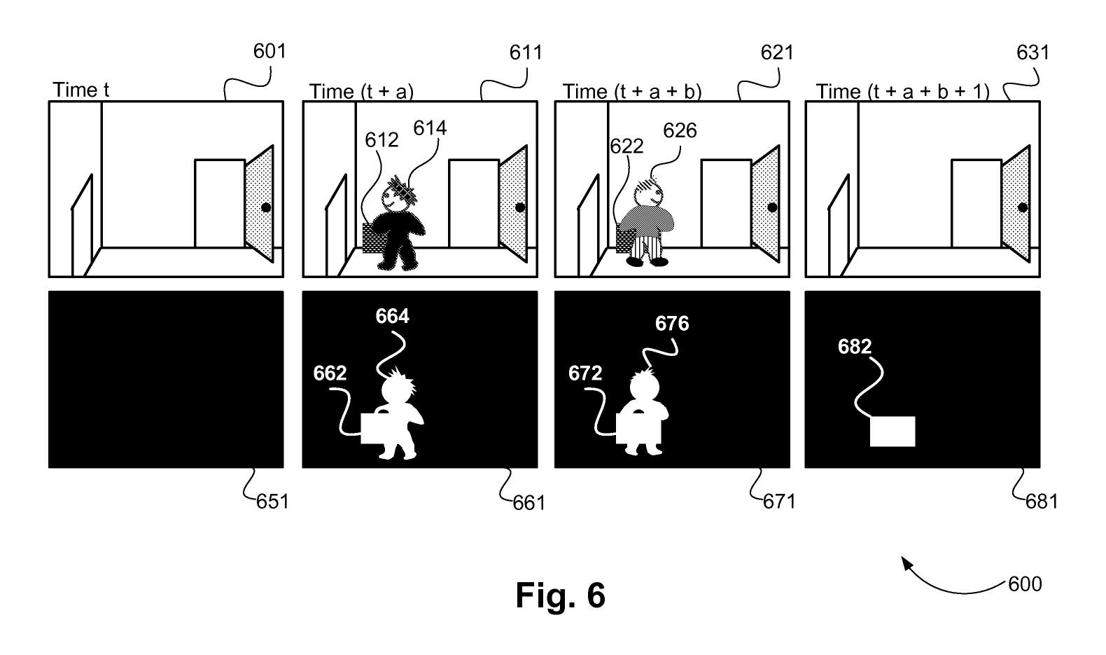

FIG. 6 depicts a scene captured in an image sequence over time and corresponding object detections in that scene, showing the ‘revealed background’ problem in a multi-mode system. Frames sampled from the image sequence and shown in FIG. 6 include a first frame 601 at time (t), a second frame 611 at time (t+a), a third frame 621 at time (t+a+b), and a fourth frame 631 at time (t+a+b+1). The first frame 601, second frame 611, third frame 621, and fourth frame 631 are successive frames in the image sequence, but are not necessarily consecutive frames and may be separated by many frames over a long period of time. Each frame is associated with a corresponding output of foreground objects detected in the respective frame. The first frame 601 has an associated output 651, the second frame 611 has an associated output 661, the third frame 621 has an associated output 671, and the fourth frame 631 has an associated output 681.

Initially at time t, the scene depicted in the first frame 601 is empty and includes no foreground objects. With at least one matching mode model 260 at each visual element model 250, based on the visual element model having at least one background mode model, the input frame 601 causes no new mode models to be created and all of the matched mode models are considered to be background. The output 651 of this first frame 601 is blank and does not contain any detections.

At a later time (t+a), the incoming second frame 611 has new elements. The new elements are a person 614 bringing an object such as a table 612 into the scene. Both the person 614 and the new table 612 are shown as foreground objects 664 and 662 in the output 661 for this frame 611.

At a still later time (t+a+b), the incoming frame 621 has different elements again. The table seen in frame 611 with a given appearance 612 is still visible in frame 621 with a similar appearance 622. Frame 621 also shows a different person 626 from the person 614 shown before in the frame 611. When the person 626 leaves the room, he takes the abandoned object 612 with him. Both the person 626 and the new table 622 are shown as foreground objects 676 and 672 in the output 671 for this frame 621.

In the next frame 631 at time (t+a+b+1), the scene is empty, as in frame 601 at time (t). However, the background has been covered by the abandoned table 612 for too long. Therefore, the mode models representing the background have expired and have been deleted during the time between time (t) and time (t+a+b). In the output 681 of this frame 631, the revealed background is falsely detected as foreground 682.

FIG. 7 is a flow diagram of a process 700 corresponding to the deletion process of step 370 of FIG. 3, in which a mode model has to be removed from the system to release some memory and create space for creating a new mode model. The process 700 begins at a Start step 705 when control is passed from the memory checking step 360. Control passes from step 705 to step 710 for determining a candidate deletion mode model m.

One embodiment for determining a candidate deletion mode model is to choose a mode model with an earliest expiry time from the set of mode models in the visual element model. The mode model is also referred to as a previously stored mode model. After a candidate deletion mode model m is determined, control passes from step 710 to a decision step 720 to determine whether a temporal attribute associated with the selected candidate mode model m satisfies a predefined threshold T. Step 720 performs a test to check whether a temporal attribute of m satisfies a threshold T, say 2000 frames. In one embodiment, the temporal attribute is the age of a mode model. The age of a mode model is defined as the difference between the current frame number and the frame number at which the mode model was created. If the age of the mode model is greater than or equal to the threshold T, then the mode model is classified as background. Conversely, if the age of the mode model is less than the threshold T, then the mode model is classified as foreground. If the candidate deletion mode model m is determined to be foreground, then candidate deletion mode model m is deleted. However, if the candidate deletion mode model m is determined to be background, then a further check is required before deleting candidate deletion mode model m, to ensure that the mode model m is not the only background mode model. In one embodiment, the threshold T is predetermined If the test in step 720 fails and the temporal attribute of the candidate mode model m does not satisfy the threshold T, No, then mode model m is considered to be foreground and control passes from step 720 to step 716, which deletes the mode model m. Control passes from step 716 to an End step 799 and the process 700 terminates.

If the test in step 720 succeeds and the temporal attribute of the candidate mode model m does satisfy the threshold T, Yes, then mode model m is considered to be background and control passes from step 720 to decision step 725, which performs a test to check whether mode model m is the only background. In one implementation, the test to check whether mode model m is the only background is done by comparing the age of one other mode model in the visual element model with a second threshold Tₖ. In one embodiment, Tₖ=T. In another embodiment, the threshold Tₖ is different from the threshold T. In a situation in which the scene will most likely have at least one background mode model, the second threshold Tk can be more relaxed (smaller) than threshold T to accommodate mode models that will soon change into a background mode model. In yet another embodiment, Tₖ is a set of thresholds, represented as (T_{K}_{₁}, T_{K}_{₂}, . . . , T_{K}_{_{N}}). In this case, a number N of modes that satisfy their respective thresholds are kept in the memory 106 such that foreground/background separation can occur. This embodiment is useful for a scene with, say, two known background modes. For example, a scene with an open door and a scene with a closed door. Thus, the number of modes N is equal to two, such that both the background modes are kept for foreground/background separation in subsequent scenes. If the test in step 725 succeeds and there does exist another mode model K that satisfies the threshold Tₖ, Yes, then control passes from step 725 to step 715, which deletes the mode model m. Control passes from step 715 to the End step 799 and the process terminates.

If the test in step 725 fails and there is not at least one other mode model K that satisfies the threshold Tₖ (classified as background), No, then mode model m is considered to be the only mode model that is classified as background (satisfies the threshold T), and control passes from step 725 to step 730 to determine the next candidate deletion mode model n. The method retains mode model m, as mode model m is the only background mode model, and seeks to identify a new candidate deletion mode model from the other mode models in the visual element model.

One embodiment of determining the next candidate deletion mode model n is to find the mode model that has the second earliest expiry time. After determining the next candidate deletion mode model n in step 730, control passes from step 730 to step 740, which removes mode model n from the visual element mode 250. Control passes from step 740 to the End step 799 and the process 700 terminates.

FIG. 8 is a flow diagram of a process 800 corresponding to the update process 390 of FIG. 3, in which all the mode models will be checked for expiry. If a mode model has reached an associated expiry time, the expired mode model will be deleted from the set of mode models in the visual element model 250. The process 800 begins at a Start step 805 when control is passed from the matching step 340. Control then passes to a first step 810, which is a decision step checking whether there are any mode models for processing.

If at step 810 there are no more mode models found, No, control passes to an End step 899 and the process 800 terminates.

If at step 810 there is at least one more mode model found, Yes, then control passes to step 820 and the processor 105 determines a candidate deletion mode model, mode model m. In one embodiment, the candidate deletion mode model is the model having an associated expiry time equal the current frame number. Control passes from step 820 to step 834, which performs a test to check whether a temporal attribute of the candidate deletion mode model m satisfies a threshold T. In one embodiment, the temporal attribute is the age of a mode model. If the age is greater than or equal to a threshold T, then the mode model is classified as background. Conversely, if the age is less than the threshold T, then the mode model is classified as foreground. In one embodiment, the threshold T is predetermined If the temporal attribute of the candidate deletion mode model m is not greater than or equal to the threshold T and the test in step 834 fails, No, then the candidate deletion mode model m is foreground and control passes from step 834 to step 837, which removes the mode model m. Control passes from step 837 and returns to step 810 to check whether there is any other mode model remaining.

If the test at step 834 succeeds and the temporal attribute of mode model m is greater than or equal to the threshold T, Yes, then the candidate deletion mode model m is classified as background and control passes from step 834 to decision step 835, which performs another test to check if there exists at least one other mode model K in the visual element 250 that satisfies a threshold Tₖ. In one embodiment Tₖ=T. In another embodiment, the threshold Tₖ is different from the threshold T. In yet another embodiment, the test 835 is whether there are a pre-determined number N of modes, represented as K₁, K_{2,} . . . , K_{N} satisfying their thresholds represented as T_{K}_{₁}, T_{K}_{₂}, . . . , T_{K}_{_{N}}. In this case, a number N of modes that satisfy their respective thresholds are kept in the memory 106 such that foreground/background separation can occur. This embodiment is useful for a scene with, say, two known background modes. For example, a scene with an open door and a scene with a closed door. Thus, the number of modes N is equal to two, such that both the background modes are kept for foreground/background separation in subsequent scenes.

If the test at step 835 succeeds, that is there does exist another mode model K that satisfies a threshold Tₖ, Yes, control passes from step 835 to step 836, which removes the mode model m. Control passes from step 836 and returns to step 810 to check whether any more mode models remain.

If the test at step 835 fails, and there is not at least one other mode model that satisfies the threshold Tₖ, No, mode model m is retained and control returns to step 810 to check whether any more mode models remain.

In FIG. 7, steps 720, 725, and 715 may be considered as a functional block 750, shown with a dotted line. In FIG. 8, steps 834, 835, and 836 may be considered as a functional block 830, shown with a dotted line. The functionality of blocks 750 and 830 prevents the only background mode model from being deleted and allows the only background mode to be kept as long as possible, since it is the only background the system has seen so far. This enables an embodiment of the present disclosure to model the background accurately.

Returning to FIG. 6, when the background mode models are created and stored in the system when processing the first frame 601 at time t, and those background mode models are not matched between the first frame 601 at time (t) and the fourth frame 631 at time (t+a+b+1), the approach of the present disclosure prevents the background mode model from being deleted between the frame 611 at time (t+a) and the frame 612 at time (t+a+b). When the background is revealed in frame 631 at time (t+a+b+1), the background still matches to the background mode model created in frame 601, despite the background mode model not having been matched for a long time.

### INDUSTRIAL APPLICABILITY

The arrangements described are applicable to the computer and data processing industries and particularly for the video imaging and surveillance industries.

The foregoing describes only some embodiments of the present invention, and modifications and/or changes can be made thereto without departing from the scope and spirit of the invention, the embodiments being illustrative and not restrictive.

We claim:

1. A method of updating a visual element model of a scene model associated with a scene captured in an image sequence, said visual element model including a set of mode models for a visual element corresponding to a location of said scene, the method comprising:
identifying a first mode model from the set of mode models for the visual element model as a candidate deletion mode model; and
removing the identified candidate deletion mode model from the set of mode models for the visual element model, to update the visual element model for the video sequence, when a first temporal attribute associated with the candidate deletion mode model satisfies a first threshold and a second temporal attribute associated with a second mode model in the set of mode models satisfies a second threshold.

2. The method according to claim 1, wherein said updated visual element model is utilized in foreground/background separation of at least a plurality of images in said image sequence.

3. The method according to claim 1, wherein identifying said candidate mode model is based on an expiry time of said first mode model.

4. The method according to claim 1, comprising the further step of utilizing said first threshold to classify each mode model in said set of mode models as one of a foreground mode model and a background mode model.

5. The method according to claim 1, further comprising the step of retaining the candidate deletion mode model in said set of mode models, if the first temporal attribute associated with the candidate deletion mode model is less than the first threshold.

6. The method according to claim 1, wherein the method comprises the further steps of:
removing from the set of mode models for the visual element model a mode model other than said candidate deletion mode model; and
creating a new mode model based on data associated with the visual element of an input frame from said image sequence, where:
the first temporal attribute associated with the candidate deletion mode model satisfies said first threshold, and
for each other mode model in said set of mode models, the second temporal attribute associated with said mode model does not satisfy the second threshold.

7. The method according to claim 1, further comprising the step of creating a new mode model for said set of mode models, based on data associated with the visual element of the input frame.

8. The method according to claim 1, wherein the first threshold is equal to the second threshold.

9. The method according to claim 8, wherein said first temporal attribute is an age of said first mode model and said second temporal attribute is an age of said second mode model.

10. The method according to claim 1, further comprising the steps of:
determining if a memory space to store the visual element model is full; and
performing said identifying step and said removing step if the memory space to store the visual element is full.

11. A method of updating a visual element representation of a scene representation associated with a scene captured in an image sequence, said visual element representation including a set of modes for a visual element, the method comprising the steps of:
identifying a mode from the set of modes for the visual element representation as a candidate deletion mode; and
removing the identified candidate deletion mode from the set of modes for the visual element representation, to update the visual element representation for the video sequence, when the candidate deletion mode is a background mode and at least one other mode in the set of modes is also a background mode.

12. A computer readable storage medium having recorded thereon a computer program executable by a processor to update a visual element model of a scene model associated with a scene captured in an image sequence, said visual element model including a set of mode models for a visual element corresponding to a location of said scene, said computer program comprising:
code for identifying a first mode model from the set of mode models for the visual element model as a candidate deletion mode model; and
code for removing the identified candidate deletion mode model from the set of mode models for the visual element model, to update the visual element model for the video sequence when a first temporal attribute associated with the candidate deletion mode model satisfies a first threshold and a second temporal attribute associated with a second mode model in the set of mode models satisfies a second threshold.

13. A camera system for capturing an image sequence, said camera system comprising:
a lens system;
a sensor;
a storage device for storing a computer program;
a control module coupled to each of said lens system and said sensor to capture said image sequence; and
a processor for executing the program, said program comprising:
computer program code for capturing at least one frame in an image sequence;
computer program code for updating a visual element model of a scene model associated with a scene captured in the image sequence, said visual element model including a set of mode models for a visual element corresponding to a location of said scene, the updating including the steps of:
identifying a first mode model from the set of mode models for the visual element model as a candidate deletion mode model; and
removing the identified candidate deletion mode model from the set of mode models for the visual element model, to update the visual element model for the video sequence, when a first temporal attribute associated with the candidate deletion mode model satisfies a first threshold and a second temporal attribute associated with a second mode model in the set of mode models satisfies a second threshold; and
computer program code for utilizing the scene model to separate the foreground from the background in the scene of at least one image in the image sequence.

14. A method of performing video surveillance of a scene by utilizing a scene representation associated with said scene, said scene representation including a plurality of visual elements, wherein each visual element is associated with a visual element representation that includes a set of modes, said method comprising the steps of:
capturing an image sequence of said scene;
updating a visual element representation of said scene representation by:
identifying a mode from the set of modes for the visual element representation as a candidate deletion mode; and
removing the identified candidate deletion mode from the set of modes for the visual element representation, to update the visual element representation for the video sequence, when a first temporal attribute associated with the candidate deletion mode satisfies a first threshold and a second temporal attribute associated with a second mode in the set of modes satisfies a second threshold; and
utilizing said updated visual element representation in foreground/background separation of at least one image in said image sequence.

15. A method of updating a visual element representation for a video sequence, said visual element representation comprising a plurality of modes for a visual element representing at least a portion of the video sequence, the method comprising the steps of:
identifying a mode from the plurality of modes for the visual element as a candidate deletion mode;
comparing a temporal attribute of the candidate deletion mode to a first threshold; and
removing the candidate deletion mode of the visual element representation, to update the visual element representation for the video sequence, when there are at least a pre-determined number of modes that have the temporal attribute that satisfy a threshold associated with each of said modes.

16. A method of updating a visual element representation of a scene representation associated with a scene captured in an image sequence, said visual element representation including a set of modes for a visual element, the method comprising:
identifying a mode from the set of modes for the visual element representation as a candidate deletion mode; and
keeping the identified candidate deletion mode in the set of modes for the visual element representation when the candidate deletion mode is only a background mode in the set of modes for the visual element representation.
